(19) United States
(12) Patent Application Publication
(10) Pub. No.: US 2008/0238826 A1
(43) Pub. Date: Oct. 2, 2008

(54) PLASMA DISPLAY DEVICE

(76) Inventor: Tae-Kyoung Kang, Yongin-si (KR)

Correspondence Address: CHRISTIE, PARKER & HALE, LLP, PO BOX 7068, PASADENA, CA, 91109-7068, US

(21) Appl. No.: 12/023,940

(22) Filed: Jan. 31, 2008

(30) Foreign Application Priority Data
Mar. 26, 2007 (KR) 10-2007-0029248

(51) Int. Cl. G09G 3/28

(52) U.S. Cl. 345/64

(57) ABSTRACT

A plasma display device is provided. The plasma display device includes: a chassis base having a first side and a second side; a plasma display panel on the first side of the chassis base; a first circuit unit on the second side of the chassis base, and the first circuit unit including first electrodes; a second circuit unit electrically connected to electrodes that are drawn out from the plasma display panel, and the second circuit unit including second electrodes; and an anisotropic conductive film interposed between the first and second electrodes for electrically connecting the first electrodes to the second electrodes, wherein the anisotropic conductive film covers the second electrodes and extends to ends of the second electrodes. Accordingly, moisture penetrating into the plasma display device is reduced or prevented to avoid a short circuit and protect various terminals.

### CROSS-REFERENCE TO RELATED APPLICATION

This application claims priority to and the benefit of Korean Patent Application No. 10-2007-0029248, filed on Mar. 26, 2007, in the Korean Intellectual Property Office, the entire content of which is incorporated herein by reference.

### BACKGROUND OF THE INVENTION

(a) Field of the Invention

The present invention relates to a plasma display device.

(b) Description of the Related Art

In general, a plasma display device includes a plasma display panel for displaying images, a chassis base for supporting the panel, and a plurality of printed circuit board assemblies which are disposed on the chassis base.

The circuit board assemblies are used to drive the plasma display panel. The circuit board assemblies include a sustain electrode driving board for driving the sustain electrodes, a scan electrode driving board for driving the scan electrodes, an address buffer board for driving the address electrodes, a logic board which receives an image signal from the outside of the plasma display panel and applies control signals for driving the address, sustain, and scan electrodes, and a power supply board for supplying power.

The sustain electrode driving board and the scan electrode driving board are respectively connected to the sustain and scan electrodes, and the address buffer board is connected to the address electrodes.

In order to connect the address buffer board to the address electrodes, a driver integrated circuit package (for example, a tape carrier package (TCP)) may be used.

When tin (Sn) electrodes are used in the driver integrated circuit package, moisture penetrates due to heat caused by a high voltage and high temperature surroundings and may cause a short circuit.

### SUMMARY OF THE INVENTION

According to an aspect of the present invention, there is provided a plasma display device including: a chassis base having a first side and a second side; a plasma display panel on the first side of the chassis base; a first circuit unit on the second side of the chassis base and including first electrodes; a second circuit unit electrically connected to electrodes that are drawn out from the plasma display panel and including second electrodes; and an anisotropic conductive film which is interposed between the first and second electrodes to connect the first electrodes to the second electrodes, wherein the anisotropic conductive film covers the second electrodes and extends to at least ends of the second electrodes.

In the above aspect of the present invention, the first circuit unit may face the second circuit unit.

In addition, the anisotropic conductive film may protrude from at least one of the ends of the second electrodes in a length direction of the second electrodes.

In addition, the ends of electrodes include a first end and a second end. The anisotropic conductive film may protrude from the first and second ends of the first and second electrodes by different distances.

In addition, a plurality of second circuit units are electrically connected to the first circuit unit, wherein the anisotropic film comprises at least two anisotropic conductive film sections, and wherein the at least two anisotropic conductive film sections electrically connected to respective said second circuit units are coupled to each other.

In addition, a sealing member may be formed on the second circuit unit.

In addition, the sealing member may extend to the first circuit unit.

In addition, the sealing member may include at least one of epoxy or silicon.

In addition, the first electrodes may include at least one of tin (Sn), silver (Ag), or copper (Cu).

In addition, the second electrodes may include at least one of tin (Sn), silver (Ag), or copper (Cu).

In addition, the first circuit unit may include a printed circuit board (PCB).

In addition, the second circuit unit may include a tape carrier package (TCP).

### BRIEF DESCRIPTION OF THE DRAWINGS

The above and other features and aspects of the present invention will become more apparent by describing in detail exemplary embodiments thereof with reference to the attached drawings in which:

FIG. 1 is a partially exploded perspective view illustrating a plasma display device according to an embodiment of the present invention;

FIG. 2 is a cross sectional view taken along line II-II of FIG. 1;

FIG. 3 is an exploded perspective view illustrating an address buffer board and a flexible circuit;

FIG. 4 is a cross sectional view illustrating a part including an anisotropic conductive film according to an embodiment of the present invention;

FIG. 5 is a top plan view illustrating a part including an anisotropic conductive film according to an embodiment of the present invention; and

FIG. 6 is a cross sectional view illustrating a sealing member according to an embodiment of the present invention.

### DETAILED DESCRIPTION OF EMBODIMENTS

The present invention will now be described more fully hereinafter with reference to the accompanying drawings, in which embodiments of the invention are shown. As those skilled in the art would realize, the described embodiments may be modified in various different ways, all without departing from the spirit or scope of the present invention. To clearly describe an embodiment of the present invention, a part not related to the description is omitted. Like reference numerals designates like elements throughout the specification.

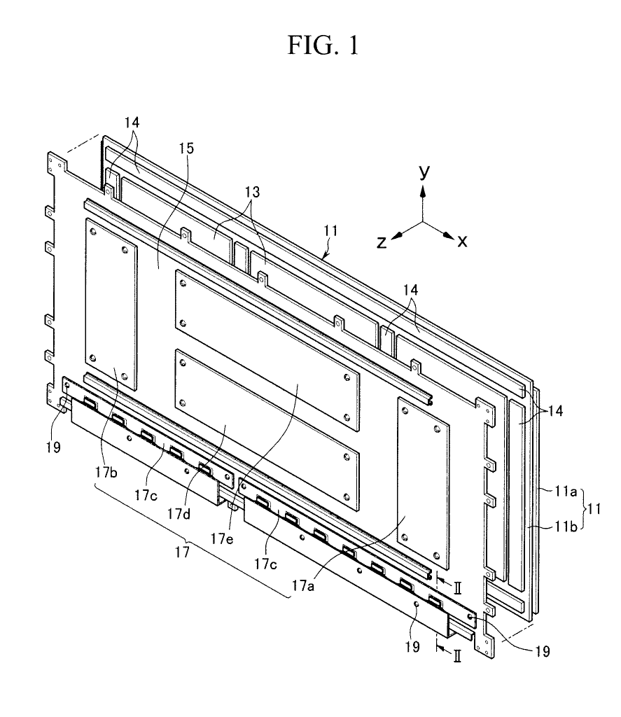

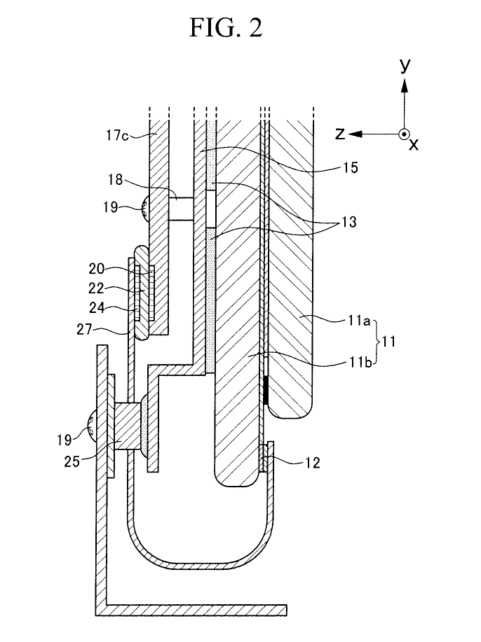

FIG. 1 is a partially exploded perspective view illustrating a plasma display device according to an embodiment of the present invention. FIG. 2 is a cross sectional view taken along line II-II of FIG. 1.

Referring to FIGS. 1 and 2, the plasma display device according to the embodiment is constructed by including a plasma display panel 11, heat dissipating sheets 13, a chassis base 15, and circuit board assemblies 17.

The chassis base 15 is adhered by double sided tapes 14 to the rear surface of the plasma display panel 11 and supports the plasma display panel 11.

The circuit board assemblies 17 are disposed on the rear surface of the chassis base 15 and electrically connected to the plasma display panel 11. The circuit board assemblies 17 are disposed on bosses 18 on the chassis base 15 and fixed by using set screws 19 that engage with the bosses 18.

The circuit board assemblies 17 include a sustain electrode driving board 17a for controlling sustain electrodes (not shown), a scan electrode driving board 17b for controlling scan electrodes (not shown), address buffer boards 17c for controlling address electrodes 12, a logic board 17d which receives an image signal from the outside of the plasma display panel 11, generates a control signal for driving the address electrodes 12 and a control signal for driving the sustain and scan electrodes, and applies the control signals to the corresponding circuit board assemblies, and a power supply board 17e for supplying power for driving the board assemblies.

The plasma display panel 11 including the front and rear substrates 11a and 11b displays images by using a gas discharge. Since the embodiment of the present invention relates to a connection relation between the plasma display panel 11 and other components, detailed description on the components of the plasma display panel 11 will be omitted.

The address buffer boards 17c and the flexible circuit 27 are used as non-limiting example to illustrate an embodiment of the present invention. Other circuit units which are connected to each other by using an anisotropic conductive film 22 may be included in the embodiment of the present invention.

The address buffer boards 17c are connected to the address electrodes 12 through the flexible circuit 27. The address buffer board 17c may be printed circuit boards (PCBs).

The flexible circuit 27 may be formed as a tape carrier package (TCP) type which includes a driver integrated circuit 25 for generating a control signal applied to the address electrodes 12.

Anisotropic conductive film (ACF) 22 is interposed between first electrodes 20 on the address buffer boards 17c and second electrodes 24 on the flexible circuit 27.

In addition, in one embodiment, the anisotropic conductive film 22 is formed as an adhesive agent type. The anisotropic conductive film 22 includes electric conduction balls.

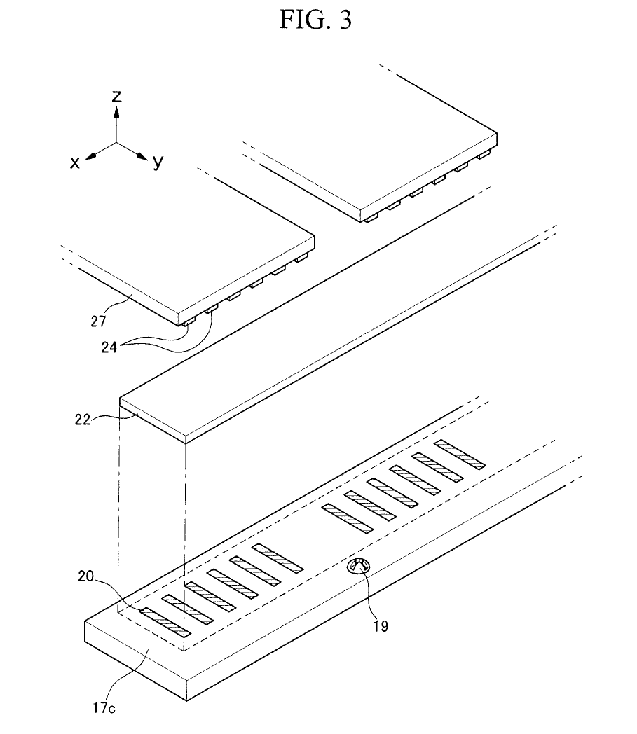

FIG. 3 is an exploded perspective view illustrating an address buffer board and a flexible circuit.

Referring to FIG. 3, the address buffer boards 17c are disposed in a z-axis direction of FIG. 3, and the flexible circuits 27 are disposed to face the address buffer boards 17c. A plurality of first electrodes 20 are arranged on an upper surface of the address buffer boards 17c. On the other hand, the second electrodes 24 are formed on a lower surface of the flexible circuits 27. The second electrodes 24 are positioned to face the first electrodes 20.

The anisotropic conductive film 22 between the flexible circuits 27 and the address buffer boards 17c extends over a planar area larger than the cross sectional areas of the first and second electrodes 20 and 24, therefore, the anisotropic conductive film 22 covers the first and second electrodes 20 and 24 to prevent the first and second electrodes 20 and 24 from being exposed to air. This aspect of the present invention can prevent impurities such as water or dust from adhering to the first or second electrodes 20 and 24 to reduce the chance for a short circuit.

The second electrodes 24 formed on the flexible circuits 27 may be made of material selected from one or more, but not limited to, silver (Ag), copper (Cu), or tin (Sn). Furthermore, in order to reduce costs for manufacturing the flexible circuits 27, the second electrodes 24 may be made of tin (Sn).

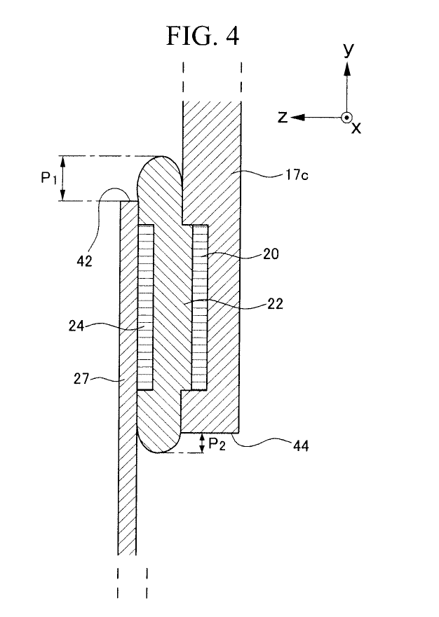

FIG. 4 is a cross sectional view illustrating a part including an anisotropic conductive film according to an embodiment of the present invention.

Referring to FIG. 4, the anisotropic conductive film 22 is interposed between the first electrodes 20 of the address buffer boards 17c and the second electrodes 24 of the flexible circuits 27 to entirely cover the first and second electrodes 20 and 24. In this particular embodiment the anisotropic conductive film 22 extends over the entire space between the flexible circuits 27 and the address buffer boards 17c which face each other.

Although the anisotropic conductive film 22 may be formed only in the space between the first and second electrodes 20 and 24, in the embodiment illustrated in FIG. 4, the first and second electrodes 20 and 24 are completely covered by the anisotropic conductive film 22

The anisotropic conductive film 22 may protrude toward both sides or both ends of the first and second electrodes 20 and 24 in their length direction. Here, the length direction is parallel to the Y-axis of FIG. 4. The protruded lengths P1 and P2 may be same or different. By way of example, in the embodiment of FIG. 4, the protruded length P1 from the end surface 42 of the flexible circuits 27 is greater than the protruded length P2 from the end surface 44 of the buffer board 17c. Alternately, the protruded length P1 may be less than the protruded length P2 in other embodiments.

When the anisotropic conductive film 22 protrudes (e.g., by a predetermined length), the contact areas between the address buffer boards 17c and the flexible circuits 27 increase. Accordingly stronger connection between the address buffer boards 17c and the flexible circuits 27 can be obtained.

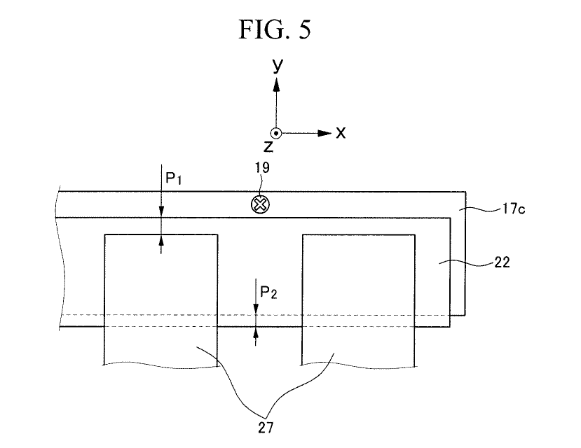

FIG. 5 is a top plan view illustrating a part where an anisotropic conductive film according to an embodiment of the present invention is interposed between flexible circuits and an address buffer board.

Referring to FIG. 5, two or more flexible circuits 27 are adhered to a single address buffer board 17c. The anisotropic conductive film 22 is interposed between each flexible circuit 27 and each address buffer board 17c. The single anisotropic conductive film 22 is so formed to be interposed between each flexible circuit 27 and the address buffer board 17c.

If a single anisotropic conductive film 22 is so formed to be interposed between only a single flexible circuit 27 and the address buffer board 17c, the number of anisotropic conductive films increases. In addition, the contact area of the anisotropic conductive film 22 decreases, as a result, the connection strength between the flexible circuit 27 and the address buffer board 17c is reduced.

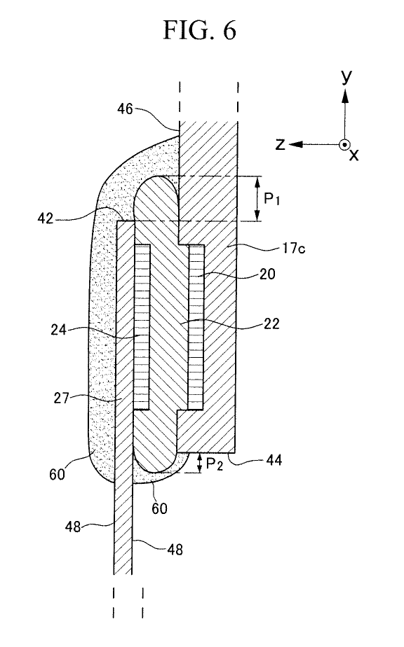

FIG. 6 is a cross sectional view illustrating a sealing member according to an embodiment of the present invention.

Referring to FIG. 6, the anisotropic conductive film 22 is interposed between the flexible circuit 27 and the address buffer board 17c. Sealing members 60 are formed along the end surface 42 and an outer surface 46 of the address buffer board 17c. In addition, the sealing member 60 may be formed along the end surface 44 of the buffer board and the outer surface 48 of the flexible circuit 27.

Since the aforementioned sealing members 60 entirely cover the anisotropic conductive film 22 and the electrodes 20 and 24, the sealing members can reduce or prevent the occurrence of the first and/or second electrodes 20 and 24 being exposed to air.

The anisotropic conductive film 22 may be formed to cover not entirely the area between the flexible circuit 27 and the address buffer board 17c but only to cover the area between the first and second electrodes 20 and 24.

The sealing members can be made of materials selected from epoxy and/or silicon.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims and their equivalents.

What is claimed is:

1. A plasma display device comprising:
a chassis base having a first side and a second side;
a plasma display panel on the first side of the chassis base;
a first circuit unit on the second side of the chassis base and comprising first electrodes;
a second circuit unit electrically connected to electrodes of the plasma display panel and comprising second electrodes facing the first electrodes; and
an anisotropic conductive film interposed between the first and second electrodes for electrically connecting the first electrodes to the second electrodes,
wherein the anisotropic conductive film covers the second electrodes and extends to at least ends of the second electrodes.

2. The plasma display device of claim 1, wherein the first circuit unit faces the second circuit unit.

3. The plasma display device of claim 2, wherein the anisotropic conductive film protrudes from at least one of an edge of the first circuit unit or the second circuit unit in a length direction of the second electrodes.

4. The plasma display device of claim 3, wherein the anisotropic conductive film protrudes from the edge of the first circuit unit and the edge of the second circuit unit by different distances.

5. The plasma display device of claim 2,
wherein a plurality of second circuit units are electrically connected to the first circuit unit,
wherein the anisotropic conductive film comprises at least two anisotropic conductive film sections, and
wherein the at least two anisotropic conductive film sections electrically connected to respective said second circuit units are coupled to each other.

6. The plasma display device of claim 1, wherein a sealing member is on the second circuit unit.

7. The plasma display device of claim 6, wherein the sealing member extends to the first circuit unit.

8. The plasma display device of claim 7, wherein the sealing member comprises at least one of epoxy or silicon.

9. The plasma display device of claim 1, wherein the first electrodes comprise at least one of tin (Sn), silver (Ag), or copper (Cu).

10. The plasma display device of claim 1, wherein the second electrodes comprise at least one of tin (Sn), silver (Ag), or copper (Cu).

11. The plasma display device of claim 1, wherein the first circuit unit comprises a printed circuit board (PCB).

12. The plasma display device of claim 1, wherein the second circuit unit comprises a tape carrier package (TCP).

13. A flat panel display device comprising:
a chassis base having a first side and a second side;
a display panel on the first side of the chassis base;
a first circuit unit on the second side of the chassis base and comprising first electrodes;
a second circuit unit electrically connected to electrodes of the display panel and comprising second electrodes facing the first electrodes; and
an anisotropic conductive film interposed between the first and second electrodes for electrically connecting the first electrodes to the second electrodes,
wherein the anisotropic conductive film covers the second electrodes and extends to at least ends of the second electrodes.

14. The flat panel display device of claim 13, wherein the first circuit unit faces the second circuit unit.

15. The flat panel display device of claim 14, wherein the anisotropic conductive film protrudes from at least one of an edge of the first circuit unit or the second circuit unit in a length direction of the second electrodes.

16. The flat panel display device of claim 15, wherein the anisotropic conductive film protrudes from the edge of the first circuit unit and the edge of the second circuit unit by different distances.

17. The flat panel display device of claim 14,
wherein a plurality of second circuit units are electrically connected to the first circuit unit,
wherein the anisotropic conductive film comprises at least two anisotropic conductive film sections, and
wherein the at least two anisotropic conductive film sections electrically connected to respective said second circuit units are coupled to each other.

18. The flat panel display device of claim 13, wherein a sealing member is on the second circuit unit.

19. The flat panel display device of claim 18, wherein the sealing member extends to the first circuit unit.

20. The flat panel display device of claim 19, wherein the sealing member comprises at least one of epoxy or silicon.
